(19) United States
(12) Patent Application Publication
(10) Pub. No.: US 2007/0105002 A1
(43) Pub. Date: May 10, 2007

(54) Fuel battery

(75) Inventors: Fumio Hashimoto, Nagoya-shi (JP); Kunio Komori, Nukata-gun (JP)

Correspondence Address: DARBY & DARBY P.C., P. O. BOX 5257, NEW YORK, NY, 10150-5257, US

(73) Assignee: TECHNO SCREW CO., LTD., NAGOYA-SHI (JP)

(21) Appl. No.: 10/597,890

(22) PCT Filed: Feb. 3, 2005
(86) PCT No.: PCT/JP05/01575

§ 371 Date: Sep. 11, 2006

(30) Foreign Application Priority Data
Feb. 13, 2004 (JP) 2004-036083

(51) Int. Cl. H01M 8/24

(52) U.S. Cl. 429/38

(57) ABSTRACT

A fuel battery in which a gas communication passage, wide in relation to the thickness of the unit cell, is provided and sufficient gas can be supplied to a generating section even if the fuel battery is made thin. A spacer and a separator are stacked. The spacer has a vent step groove where gas passes and a fitting step groove closed by the separator. The step grooves are formed between a square opening disposed in the center and containing a generating section and vent holes constituting manifolds. The separator has a projecting section projecting toward the fitting step groove and disposed between a gas supply section opposed to the generating section and the vent holes constituting the manifolds. The separator further has a communication groove for communicating with the projecting section along the vent holes and the gas supply section. The vent step groove is connected to the communication groove. Therefore, a gas communication passage for communication between the manifolds and the gas supply section is defined.

### CROSS REFERENCE TO PRIOR APPLICATION

This is a U.S. national phase application under 35 U.S.C. §371 of International Application No. PCT/JP2005/001575 filed Feb. 3, 2005 and claims the benefit of Japanese Application No. 2004-036083, filed Feb. 13, 2004. The International Application was published in Japanese on Aug. 25, 2005 as International Publication No. WO 2005/078837 under PCT Article 21(2).

### FIELD OF THE INVENTION

This invention relates to a fuel battery for use as a power source in automobiles and portable terminals.

### BACKGROUND OF THE INVENTION

The fuel battery is a device that causes reaction between hydrogen and oxygen in a generating section made up by joining electrodes to both surfaces of an electrolyte layer. It converts chemical energy produced by that reaction into electric energy while producing water. It is drawing attention as a system that is clean and high in electricity generating efficiency. The optimum working temperature of the fuel battery varies with the material of the ion conductor (usually proton conductor) making up the electrolyte layer. Therefore, the fuel battery is classified by the kind of the ion conductor it contains. Of such fuel batteries, one called the proton-exchange membrane fuel battery is expected for its use in automobiles and cell phones because it works at room temperatures and is relatively small in size.

In the proton-exchange membrane fuel battery, a polymer electrolyte membrane, or the proton conductor, is used as the electrolyte layer. Usually, a pair of electrodes (gas diffusion electrodes), each consisting of an electrolyte layer holding conductive particles carrying catalyst such as platinum and a gas diffusion conductive layer for diffusing supplied gas, are joined by thermo-compression bonding to both surfaces of the polymer electrolyte membrane to form a single body of generating section in which the gas diffusion electrodes and the electrolyte layer are joined together. An example of such fuel batteries are disclosed in Japanese Patent No. JP-A-2002-313358 and JP-A-2003-217339. Then the generating section is interposed between a pair of separators each having gas flow passages formed therein, to form a unit cell. A plural number of the unit cells are placed one over another to form a stack, the main part of the fuel battery.

Of the polymer electrolyte membrane mentioned above, the one using an ion exchange membrane based on perfluorosulfonic acid, typically Nafion™ is the most advanced in development, closest to the stage of practical use. However, the existing ion exchange membrane based on perfluorosulfonic acid such as Nafion is complicated in manufacturing process, high in cost, posing hindrance to the commercial application of the proton-exchange membrane fuel battery. Further, because its proton conductivity depends greatly on ambient humidity, there is a problem that the fuel battery requires a large-scale humidity control means. Thus, research and development of new proton conductors for replacing such ion exchange membranes have become active.

To improve practicality of the fuel battery as a power source in fuel battery-powered automobiles and portable terminals, the fuel battery is required of small size and high output. It is desirable to make the unit cell thin and to make the stack high density. However, reducing the unit cell structure in thickness entails a number of drawbacks. One of them is that the thinner the unit cell structure is made, the more it becomes difficult to secure passages for fuel gas and air. To explain more specifically in reference to the unit cell 102 shown in FIG. 12, manifolds 106 for flowing fuel gas and air are formed vertically in the perimeter portion of the unit cell 102, so that fuel gas and air branch from the manifold 106 and are supplied into the gas communication passages 111, from the gas flow grooves 141 formed along the contact surfaces of the gas diffusion electrode, to the fuel electrode and air electrode. Fuel gas having not reacted yet and water content on the air electrode side are discharged through different gas communication passages to the manifold 106 for discharging gas. Therefore, if the unit cell 102 of the conventional constitution is simply reduced in thickness, gas flow passages such as the gas communication passages 111 are narrowed accordingly, causing a situation in which gas supply amount to the generating section 103 is insufficient.

This invention is an attempt to solve the above described problems, and therefore, its object is to provide a fuel battery, having gas passages that are wide relative to the thickness of the unit cell, in which sufficient gas is supplied to the generating section even if the cell is reduced in thickness.

### SUMMARY OF THE INVENTION

In accordance with one embodiment of the present invention, a proton conducting gel comprises molten glass as a raw material, replacing the conventional polymer electrolyte membrane. The proton conducting gel is a substance, having a dispersion phase made of phosphoric acid chains and a dispersion medium of water, obtained by causing phosphate glass powder obtained by melting method to react with water. While the substance normally has an appropriate degree of viscosity to be easily formed, it can also be solidified by partially crystallizing or by heat treatment and the like so that it loses fluidity. The proton conducting gel exhibits proton conductivity higher than that of the Nafion at ordinary working temperatures (around 80° C.) of the proton-exchange membrane fuel battery. Further, the substance is found to have many other advantages such as stable proton conductivity with respect to ambient humidity and far lower manufacturing cost in comparison with Nafion.

Embodiments of the present invention pertain to a unit cell structure favorably using the electrolyte layer of the proton conducting gel (patent application 2003-193845). In such a structure, as shown in FIG. 12, the proton conducting gel is sandwiched with gas diffusion electrodes 130, 130 to form a thin film-shaped electrolyte layer 131. In this state, the proton conducting gel is solidified, and the electrolyte layer 131 and the gas diffusion electrodes 130, 130, are joined together to make a generating section 103. Further, the generating section 103 is fit to a spacer 105 by engaging with support projections 151, 151 to form a generating structure 110, in which the generating section 103 and the spacer 105 are united. A unit cell 102 is constituted with the generating structure 110 held between separators 4, 4 provided with gas flow grooves 141. In each unit cell 102 are formed gas communication passages 111 for supplying gas from manifolds 106 to both surfaces of the generating section 103. Incidentally, while the constitution of the unit cell 102 is developed for fitting the proton conducting gel into the electrolyte layer, it is also proposed to use with the constituting material of the electrolyte layer replaced with other proton conductor.

This invention relates to a fuel battery made by piling up a plural number of generating structures and separators, with each generating structure comprising a generating section of a thin plate shape made by joining gas diffusion electrodes to both surfaces of an electrolyte layer. The generating structure further comprises an insulating spacer surrounding the parametric edge of the generating section, with each separator formed in its center with a gas supply section having a contact section for contacting the generating section and a gas flow groove to be placed over the generating structure so that the gas supply section faces the generating section. The generating section is of a square shape and the spacer is formed in its center with a square containing opening for containing the generating section in alignment. The upside and underside of the perimeter of the containing opening are each formed with an attachment seat for the separator to attached to. Wide vent openings are formed in four positions opposing respective side edges of the containing opening. The portion between each vent opening and each side edge of the containing opening is formed with vent step grooves for passing gas and fit step grooves to be closed with the separator in pairs on upside and underside and, as for the same surface, placed by turns along the parametric direction of the containing opening. The separator is made of metallic sheet with its central upside and underside formed with square gas supply sections to be attached with its upside and underside parametric edges in contact to the attachment seat. Its parametric section is formed with four wide vent holes respectively conforming to the vent openings of the spacer in the direction of piling up and a raised portion raised on either one side for fitting into the fit step groove is formed between each side edge of the gas supply section and each vent hole. Each raised portion is formed with a communication groove communicating with the vent hole and the gas supply section along planar direction, and joining with the vent step groove of the spacer.

According to the above constitution, as the separators are attached to both surfaces of the generating structure, the unit cell is formed in which the generating section installed in the center of the generating structure faces the gas supply section provided in the center of the separator. According to one arrangement of the invention, the gas supply sections are provided on both surfaces in the center of the separator, so that a stack consisting of a plural number of piled up unit cells may be formed with the separators and generating structures placed one over another. As they are piled up, the vent openings of the spacers and the vent holes of the separators are aligned in the piling up direction. Manifolds for supplying and discharging fuel gas and air are formed in positions opposing the parametric edges of the square generating section and the gas supply section superposed in piling up direction. Also according to the invention, by attaching the separators to both surfaces of the generating structure, the raised portions of the separator are fit into the fit step grooves. At the same time, by joining the communication grooves in the raised portions to the vent step grooves, gas supply passages are formed to make communication between the manifolds and the gas supply section. In other words, the gas communication passages are formed not only with the grooves formed in the separator, but also by joining together the communication grooves formed in the separator and the vent step grooves of the spacer. Therefore, it is possible to increase the depth of the gas communication passage relative to the unit cell thickness in comparison with the conventional arrangements. Also according to the above constitution, the manifolds are formed in positions facing respective side edges of the gas supply section, while the gas communication passages make mutual communication between the manifolds located on both sides of the gas supply section through the gas supply section located on the same surface side. As a result, fuel, gas and air flowing through the manifolds are supplied from the side edge on one side of the gas supply section and flow out of the side edge on the opposite side. This makes it possible to increase the width of the gas communication passage up to the length of the side edge of the gas supply section. Furthermore, because the constitution according to the invention uses metallic sheet suited for reducing thickness and cost of the separator, it can harmonize not only with the gas flow passage but also with other constitution necessary for reducing thickness.

Here, it is proposed that the gas supply sections on both surfaces of the separator are each constituted with a plural number of projections projecting on both surface sides and having contact portions near their peaks for contacting the generating section, and with mesh-like gas flow grooves formed among the peaks of the projections. According to such an arrangement, the projections may be easily formed by a simple press process applied to a metallic sheet. It is also possible to form mesh-like gas flow grooves by forming the projections in appropriate positions, such that the gas supply sections may be formed on both surfaces of the separator.

The gas communication passage may be enlarged not only in the depth direction but also in the width direction. On the other hand, however, if the gas flow passage is widened, depression at the end portion of the generating section is weak in the thickness direction, such that the generating section is likely to deform in the thickness direction. Therefore, it is preferable to provide a support member placed in the width direction inside the mutually joined vent step groove and communication groove to bring the inside end on the vent step groove side into contact with the end portion of the generating section in the thickness direction. This makes it possible to securely hold the generating section so that it does not deform even if the generating section is mechanically pliable, which in turn makes it possible to use a thin generating section in the unit fuel battery while enlarging the gas communication passage in the width direction. Incidentally, the electrolyte layer of this invention may be made not only of the above-described proton conducting gel but also any other materials commercially available. Further, the generating structure is not limited to the one in which the generating section and the spacer are assembled to be a single member but may be one in which they are separable.

In the fuel battery described above, the gas communication passage for making communication between the manifold and the gas supply section is formed by joining together the vent step groove formed in the spacer and the communication groove formed in the separator. Therefore, it is possible to form the gas communication passage having a smaller thickness relative to the thickness of the unit cell in comparison with conventional arrangements. Therefore, it is possible to make the unit cell thinner, make the stack of a higher density, and realize a fuel battery that is compact and of a high output. Also according to the invention, because the manifolds are formed to face respective side edges of the gas supply section, and the mutually opposing manifolds on both sides of the gas supply section communicate with the gas supply section on the same side, the gas communication passage may be widened up to the same width as the side edge length of the gas supply section. Further, because this arrangement uses a separator made of metallic sheet suited for reducing thickness and cost, it also provides an advantage of favorably harmonizing with other constitution suited for reducing thickness.

In case the gas supply sections on both surfaces of the separator are constituted with a plural number of projections directed toward one surface side and the other surface side with contact portions for contacting the generating section in the vicinity of their peaks and with mesh-like gas flow grooves formed among the peaks of the projections, it is possible to easily form the gas passages on both surfaces of the metallic sheet at a low cost.

Further, in case a support member placed in the width direction inside the mutually joined vent step groove and communication groove to bring the inside end on the vent step groove side into contact with the end portion of the generating section in the thickness direction is provided, the end portion of the generating section may be held in a stabilized manner even if the gas communication passage is enlarged in the width direction.

### BRIEF DESCRIPTION OF THE DRAWINGS

FIG. 1 is an enlarged side view of a stack 8 made by piling up unit cells 2.

FIG. 2 is an exploded perspective view of the stack 8.

FIG. 3 shows the section A-A in FIG. 1.

FIG. 4 shows the section B-B in FIG. 3.

FIG. 5 is a plan view of a generating structure 10.

FIG. 6 shows the section C-C in FIG. 5.

FIG. 7 is an exploded perspective view of a separator 4 and a support member 9.

FIG. 8 is a plan view of the separator 4.

FIG. 9 shows the section D-D in FIG. 8.

FIG. 10 is a plan view of the support member 9.

FIG. 11 is a view as seen from the lower section in FIG. 10.

FIG. 12 is a side view in vertical section of a conventional unit cell 102.

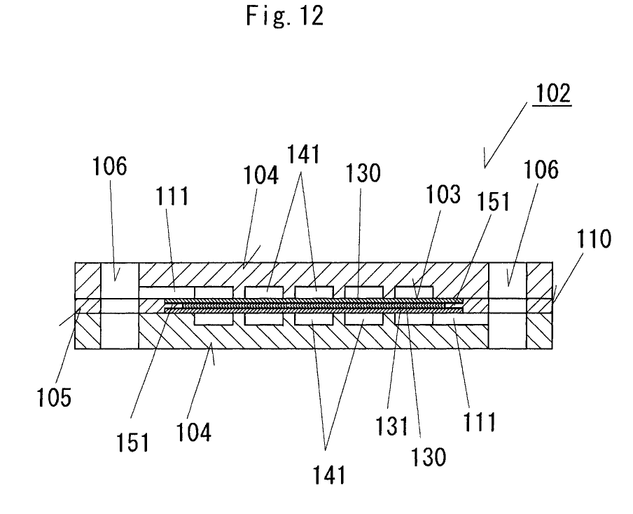

### DETAILED DESCRIPTION

For convenience, below is a brief description of several of the reference numerals and symbols mentioned throughout the following detailed description.
1: fuel battery
2, 102: unit cell
3, 103: generating section
4, 104: separator
5, 105: spacer
6a-6d, 106: manifold
7: positioning hole
8: stack
9: support member
10, 110: generating structure
11a-11d, 11: gas supply passage
30a, 30b, 130: gas diffusion electrode
31, 131: electrolyte layer
40: gas supply section
42: gas flow groove
42: round projection
43: vent hole
44: raised portion
45: communication groove
46: through hole
47: contact portion
48: contact seat surface
50: containing opening
51, 151: support projection
52: vent opening
53a: vent step groove
53b: fit step groove
54: through hole
55: attachment seat
90: support plate
91: leg

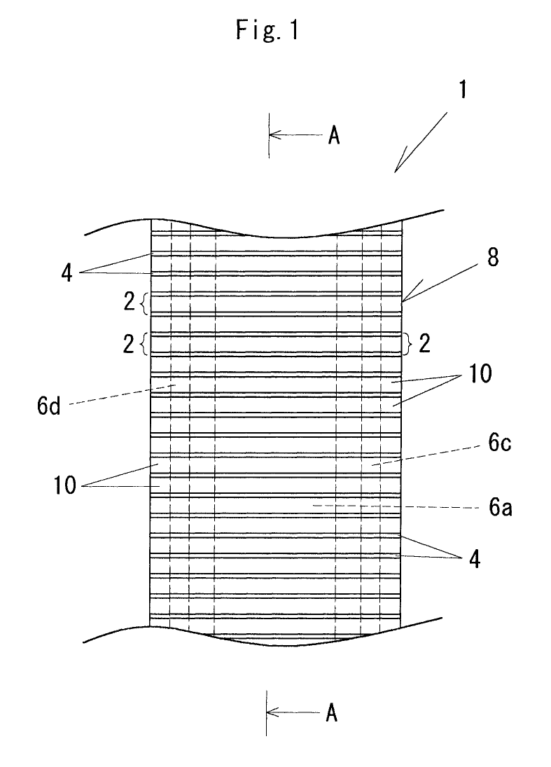

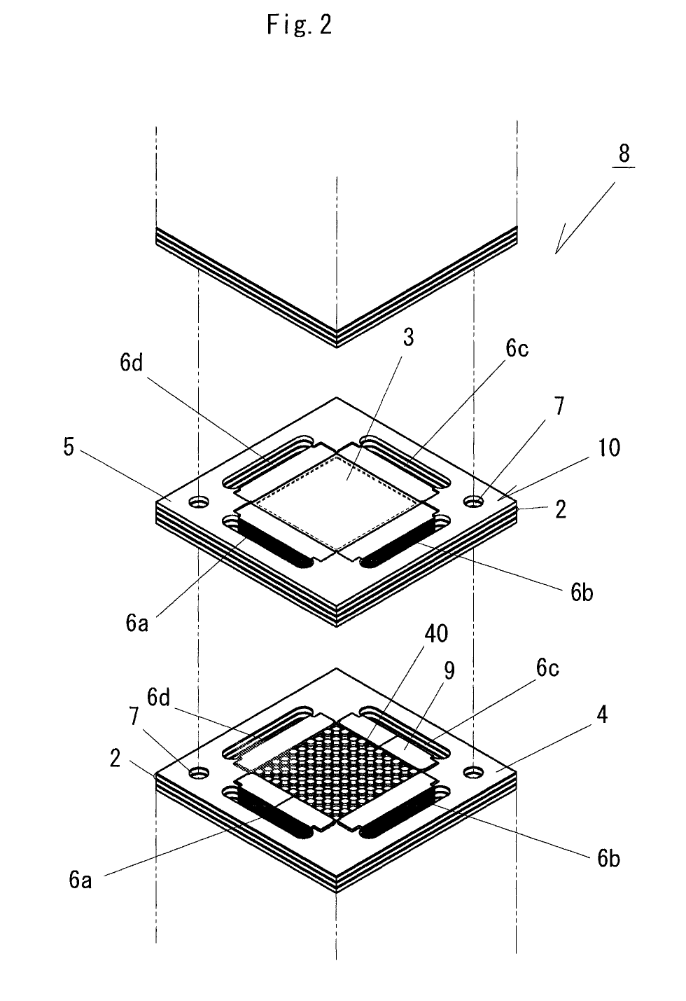

An embodiment of the invention is described with reference to the drawings. FIGS. 1 and 2 show a stack 8 of a fuel battery 1 in accordance with a first embodiment. The stack 8 is made by piling up a plural number of thin plate-shaped, rectangular unit cells 2. The stack 8 is provided with four, wide manifolds 6a-6d running vertically through the parametric portions of the unit cells 2. The manifolds 6a-6d of the unit cells 2 are: the manifold 6a for supplying fuel gas (hydrogen) to the fuel electrode side, the manifold 6b for supplying air (oxygen) to the air electrode side, the manifold 6c for discharging fuel gas having not reacted in the unit cells 2 out of the fuel electrode side, and the manifold 6d for discharging water content produced by the cell reaction and air after the reaction out of the air electrode side. The stack 8 is formed with positioning holes 7, 7 running through its comer portions. The unit cells 2 are stacked in alignment as positioning rods (not shown) are inserted into the positioning holes 7, 7. While gas supply devices for forcing fuel, gas and air into the manifolds 6a, 6c and current collectors as well as the stack 8 are attached to the fuel battery 1, these devices may be similar in constitution to those of the known proton-exchange membrane fuel battery, and therefore, their description is omitted.

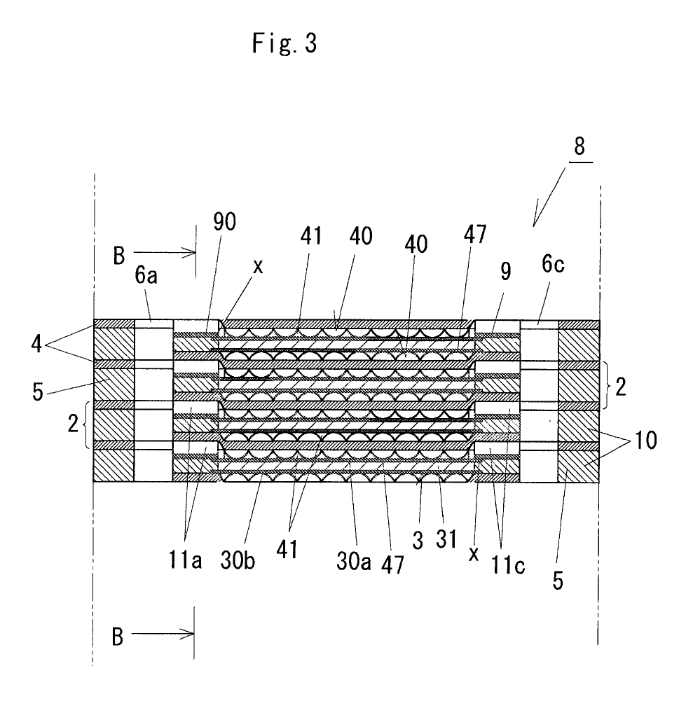

As shown in FIGS. 2 and 3, the unit cell 2 includes: a thin plate-shaped generating section 3 is surrounded with a flat spacer 5 to form a single body of generating structure 10, with its both surfaces covered with separators 4, 4, with their centers each formed with a gas supply section 40. The gas supply sections 40 formed on both upper and lower surfaces of the separator 4, as the upper and lower gas supply sections 40 come into contact with the generating sections 3, are commonly used with the neighboring unit cells 2. In other words, the stack 8 is formed by alternately piling up the generating structures 10 and the separators 4. Further, according to this embodiment as will be described later, a support member 9 for supporting the parametric portion of the generating section 3 in the thickness direction is provided between the generating structure 10 and the separator 4.

The generating section 3 is made by joining gas diffusion electrodes 30a and 30b to both surfaces of the electrolyte layer 31. The gas supply section 40 faces and contacts the gas diffusion electrodes 30a and 30b of the generating section 3, so that, through the contact portion 47, the gas diffusion electrodes 30a and 30b come into electrical contact with the separator 4. The gas supply section 40, excluding the contact portion 47, is made a gas flow groove 41 for gas to flow along the gas diffusion electrodes 30a and 30b . Through the gas flow groove 41, fuel and gas are supplied to the gas diffusion electrodes 30a and 30b, and water content produced in the generating section 3 flows toward the gas flow groove 41.

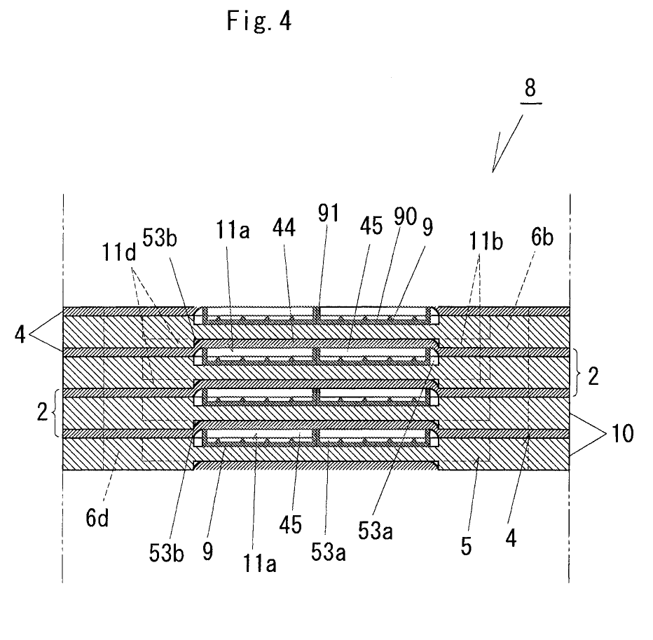

As for the unit cells 2 in FIG. 3, its upper side is assumed to be the fuel electrode while lower side the air electrode. As seen in FIGS. 3 and 4, gas communication passages 11a and 11c for circulating fuel gas to the gas supply section 40 are formed between the gas supply section 40 in contact with the upper surface of the generating section 3 and the manifolds 6a, 6c for letting fuel gas flow. In other words, as for the unit cell 2 of this embodiment, the fuel gas flowing through the manifold 6a on the left side in FIG. 3 flows through the gas communication passage 11a, and is supplied from the gas flow groove 41 on the upper side (fuel electrode side) of the generating section 3 to the gas diffusion electrode 30a on the fuel electrode side. Fuel gas having not reacted flows through the gas communication passage 11c to the manifold 6c on the right side in FIG. 3.

Referring to FIG. 4, gas communication passages 11b and 11d for circulating air to the gas supply section 40 are formed between the gas supply section 40 contacting the air electrode side of the generating section 3 and the manifolds 6b, 6d through which air flows. Similar to the fuel electrode side, the oxygen flowing through the manifold 6b on one side flows through the gas communication passage 11b to the gas flow groove 41 on the air electrode side, and is supplied to the gas diffusion electrode 30b on the air electrode side. Water content produced in the gas diffusion electrode 30b by cell reaction and air having not reacted pass through the gas communication passage 11d and flow out to the manifold 6d on the other side.

As shown in FIG. 2, in the unit cell 2, the manifolds 6a, 6c for flowing fuel gas are formed on both sides of the gas supply section 40, and the manifolds 6b, 6d for flowing air are formed on both sides of the gas supply section 40, so that fuel gas and air flow crisscross each other in the gas supply sections 40, 40 contacting the fuel electrode side and the air electrode side of the generating section 3. Incidentally, the fuel electrode side and the air electrode side of the unit cell 2 of this embodiment are symmetric on both sides. Because their difference is on the operational matter such as difference in the gas supplied to the gas supply section 40, their constitution is explained without discrimination between both the electrodes. As a matter of course, because this is an embodiment, the present invention need not be embodied with identical constitution on both the fuel electrode side and the air electrode side. Therefore, there is no problem in making both the electrodes asymmetric in constitution.

The constitution of the generating structure 10 and the separator 4 making up the unit cell 2 is described below. The generating structure 10 is of a square shape made by surrounding the thin plate-shaped generating section 3 with the flat-shaped insulating spacer 5. The generating section 3 and the spacer 5 are inseparably assembled by causing the entire perimeter of the generating section 3 to engage with the support projection 51 formed on the inside parametric portion of the containing opening 50 formed in the center of the spacer 5.

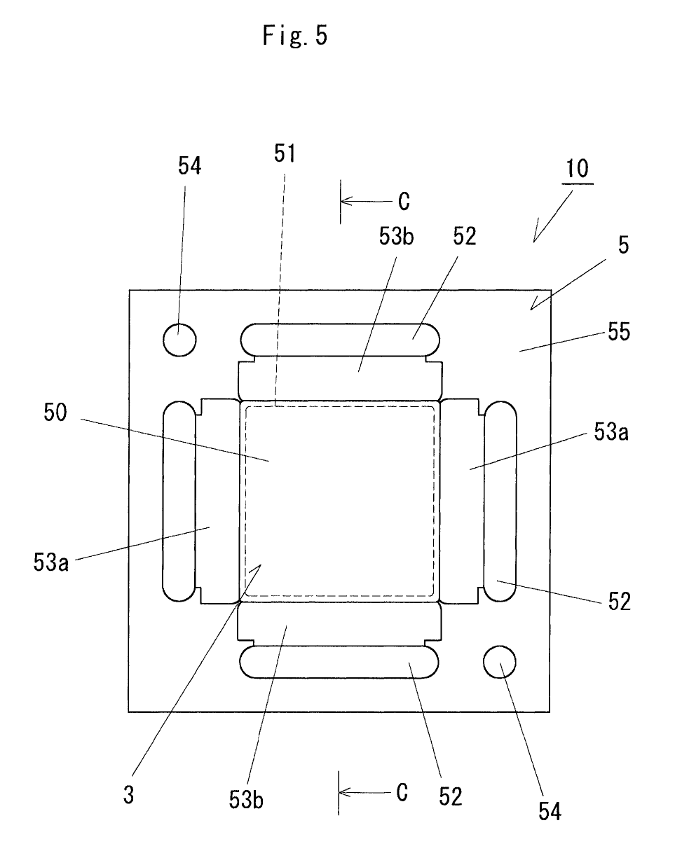

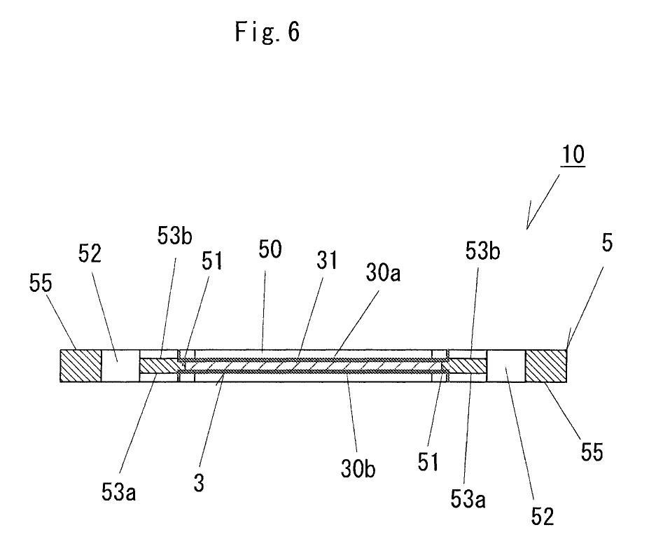

As shown in FIGS. 5 and 6, the generating section 3 is made by joining a pair of gas diffusion electrodes 30a and 30b to both opposite surfaces of the evenly thick, film-shaped electrolyte layer 31.

The gas diffusion electrodes 30a and 30b are each made of a porous carbon paper, of a thickness of 1 mm or less, cut to a square shape. One entire surface of the carbon paper is applied with carbon particles carrying platinum to form a catalyst layer. The gas diffusion electrodes 30a and 30b may favorably use gas diffusion electrodes made up of a catalyst layer and a gas diffusion conductive layer that are used in existing proton-exchange membrane fuel battery. Therefore, details on their constitution and manufacturing process are omitted here. Further, while the gas diffusion electrodes 30a and 30b used are preferably about the same in shape, they may be different in materials and catalyst conforming to the cell reaction of both the electrodes.

The constituent material used in the electrolyte layer 31 is proton conducting gel obtained from calcium phosphate glass. The proton conducting gel of this embodiment was made in the following process. First, dry mixed powder of calcium carbonate and phosphoric acid was prepared to be a composition of 50 mol percent with phosphoric acid converted to P₂O₅. Then, the dry mixed powder is melted in an electric furnace through heat treatment at 1300 degrees C. for 0.5 hours. After that, the molten matter is let to flow onto a carbon plate and rapidly cooled down to room temperatures to obtain calcium phosphate glass. The calcium phosphate glass obtained is pulverized in a mortar until the particle diameter is 10 micrometers or less. The obtained powder is then put into a plastic Petri dish, stirred while adding the same weight of distilled water, covered with a 11d to prevent drying, and let it stand in that state for three days at room temperatures. This causes phosphate glass powder to react with water, so that pliable proton conducting gel is obtained in which calcium phosphate molecule chains are dispersed in water. The proton conducting gel is put between a pair of gas diffusion electrodes 30a and 30b with their catalyst layers facing inward, heat-treated (for example at a temperature of 90 degrees C., a humidity of 90 percent, for six hours) with the proton conducting gel in the state of being formed and held in a thin film shape. The proton conducting gel is solidified to make it an electrolyte layer 31 that is unlikely to deform. At the same time, the electrolyte layer 31a and the gas diffusion electrodes 30a and 30b are inseparably joined together into a single generating section 3.

The spacer 5 is made by cutting out a rectangular Teflon sheet with its center formed as shown in FIG. 5 with a square containing opening 50 for containing the generating section 3. The containing opening 50 is formed in a square shape to conform to the gas diffusion electrodes 30a and 30b and to be able to contain the generating section 3 in alignment. As shown in FIGS. 5 and 6, support projections 51 projecting inward for contacting the perimeter edges of the gas diffusion electrodes 30a and 30b are provided on the perimeter edges of the containing opening 50. The projection 51 is provided as shown in FIG. 6 in the center of thickness of the containing opening 50. The inside perimeter of the spacer 5 is formed with an inward directed rectangular projection in vertical section.

Upper and lower sides of the perimeter of the spacer 5 are formed with attachment seats 55 for the separator 4 to be attached to. The attachment seat 55 defines the thickness of the generating section 3 so that the gas supply section 40 comes into contact with the gas diffusion electrodes 30a and 30b under an appropriate force and that no excessive force is applied to the generating section 3 in the state of the separator 4 attached to the generating structure 10. Four positions opposite the perimeter edges of the containing opening 50 are each formed with a vent opening 52. The vent opening 52 is approximately the same in length as the perimeter edge of the containing opening 50 to make up the manifolds 6a-6d when piled up. Two through holes 54, 54 for making up the positioning holes 7 are bored in two parametric comers.

A vent step groove 53a and a fit step groove 53b are formed on upper and lower sides of the portion between each vent opening 52 and each side edge of the containing opening 50. The vent step groove 53a and the fit step groove 53b are formed as shown in FIGS. 5 and 6 to form a pair on upper and lower sides and, as for the same side, placed alternately along the parametric direction of the containing opening 50. In other words, on the same surface of the spacer 5, the vent step grooves 53a, 53a oppose each other, and the fit step grooves 53b, 53b oppose each other across the containing opening 50. Incidentally in this embodiment, the vent step groove 53a and the fit step groove 53b are not made different in shape, so that they are used in common.

The generating section 3 and the separator 4 are put together simultaneously with making the generating section 3. In other words, in the manufacturing process of the generating section 3 described above, the generating section 3 is made by placing the pliable proton conducting gel between a pair of the gas diffusion electrodes 30a and 30b and then solidifying the proton conducting gel. In this embodiment, however, the support projections 51 for the spacer 5 are interposed between the perimeter edges of the gas diffusion electrodes 30a and 30b simultaneously with placing the proton conducting gel between the gas diffusion electrodes 30a and 30b . While holding the above state unchanged with a jig or the like, proton conducting gel is solidified to produce the generating section 3 in which the electrolyte layer 31 is tightly attached to the gas diffusion electrodes 30a and 30b . At the same time, the generating section 3 may be fit into the containing opening 50 by causing it to engage with the support projection 51 of the spacer 5.

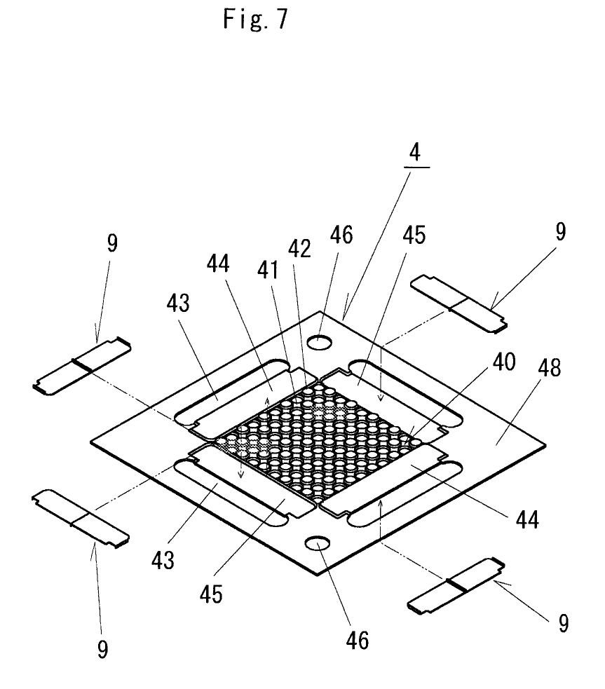

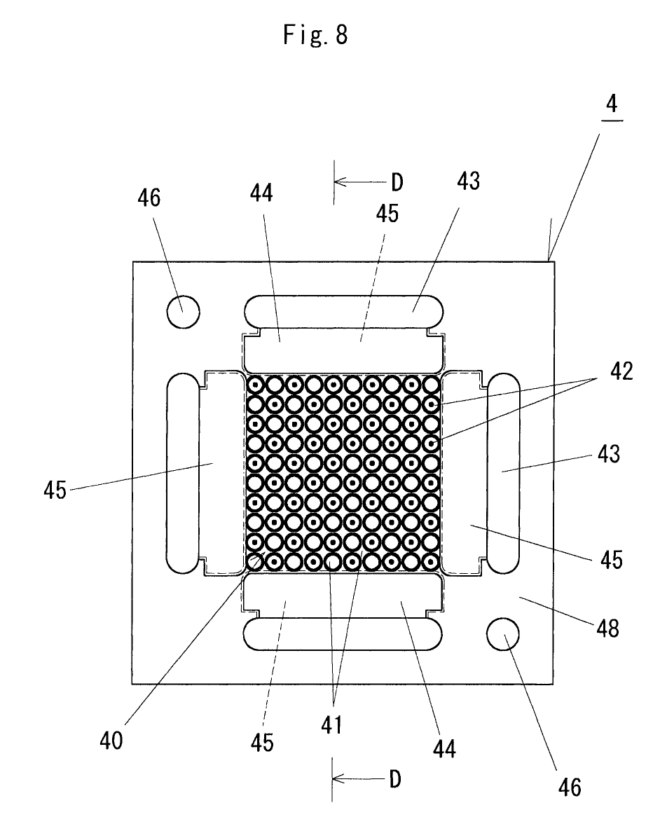

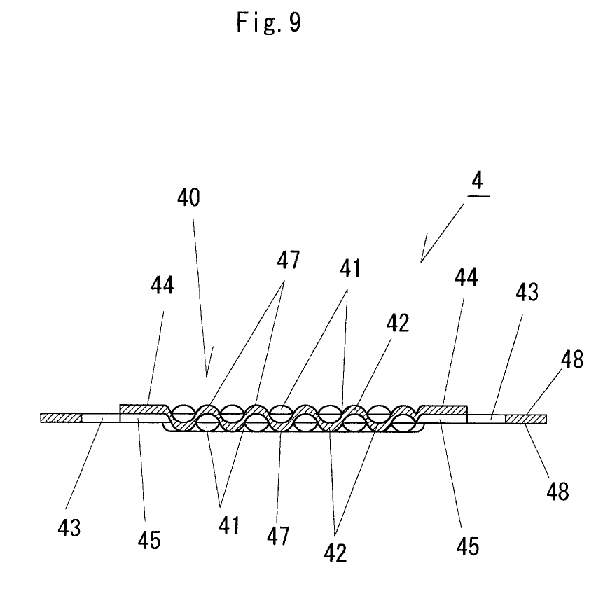

The separator 4, as shown in FIGS. 7-9, is made of a square metallic sheet with a square gas supply section 40 formed in its center and with both sides of its perimeter portion made as contact seat surfaces 48 for tightly contacting the attachment seat 55 of the spacer 5. As the materials for constituting the separator 4 those used for the separator of the proton-exchange membrane fuel battery, such as stainless steel and titanium with excellent corrosion resistance and conductivity may be favorably used.

The gas supply section 40 is formed with a plural number of round projections 42 formed to project on upper and lower surfaces of the metallic sheet. The round projections 42 are formed by press-forming the metallic sheet with crisscross rows of projections 42 projecting alternately on opposite surfaces. As for the gas supply sections 40 on both upper and lower surfaces, the portion near the peak of each round projection 42 is made a contact portion 47 for contacting the generating section 3, while the portion excluding the contact portion 47 is made a mesh-like gas flow groove 41. According to this embodiment as described above, the gas supply section 40 is brought into contact with the generating section 3 through the portions near the peaks of a plural number of the round projections 42, so that the contact portions 47 are made discontinuous in the planar direction, and that the mesh-like gas flow grooves 41 are formed to meander among the contact portions 47. As a result, the gas flow grooves 41 of the gas supply section 40 permits gas to flow crisscross along planar direction. Therefore, fuel gas and air may be caused to flow crisscross each other through the gas supply sections 40 on upper and lower surfaces. As described above, because the gas supply section 40 of such a shape may be made by simply press-processing a metallic sheet, it has an advantage of being manufactured easily at a low cost. The gas supply section 40 and the generating section 3 are both of a square shape so that, when piled up in contact with each other, they are almost conforming as seen in piling up direction. However, the gas supply section 40 is made slightly smaller than the surface of the generating section 3 so that the perimeter of the generating section 3, when piled up, projects slightly beyond the gas supply section 40.

Elongated vent holes 43 are formed in positions, on the contact seat surfaces 48 around the gas supply section 40, opposite the side edges of the gas supply section 40. The vent hole 43 is approximately the same in length as the opposing side edge of the gas supply section 40, formed in a position aligned with the vent opening 52 of the spacer 5 in the piling up direction. The vent hole 43 and the vent opening 52 are placed one over another in the piling up direction to make up the manifolds 6a-6d . Through holes 46, 46 for making up the positioning holes 7, 7 are also formed in perimeter corners.

A rectangular, raised portion 44 raised on either one surface side is formed between each vent hole 43 and each side edge of the gas supply section 40. A communication groove 45 is formed to make communication between the vent hole 43 and the gas supply section 40 along the planar direction in each raised portion 44. The raised portion 44 is made in a shape that, when piled up, conforms to both the vent step groove 53a and the fit step groove 53b of the spacer 5 in the piling up direction. The raised portions 44 located opposite each other on both sides of the gas supply section 40 are raised on the same surface side. The raised portions 44 located adjacent to each other around the gas supply section 40 are raised on opposite surface sides. Referring to FIGS. 3 and 4, when the separators 4 and the spacers 5 are piled up one over another, the raised portion 44 is fit to the neighboring fit step groove 53b, and the neighboring communication groove 45 is joined to the vent step groove 53a, to form each of the communication passages 11a-11d of the unit cells 2.

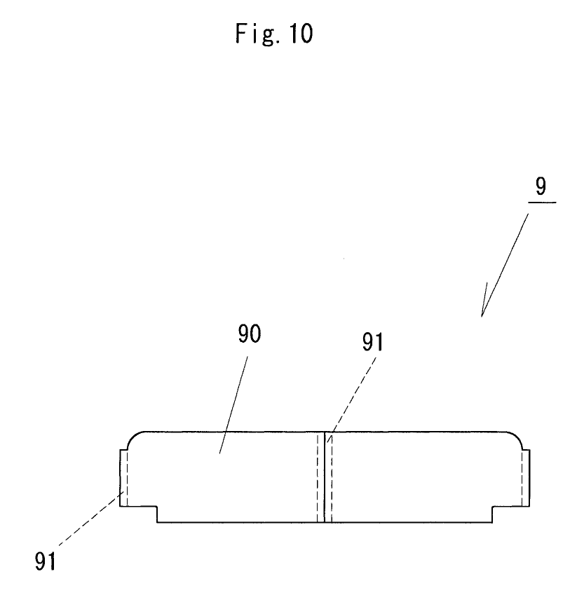

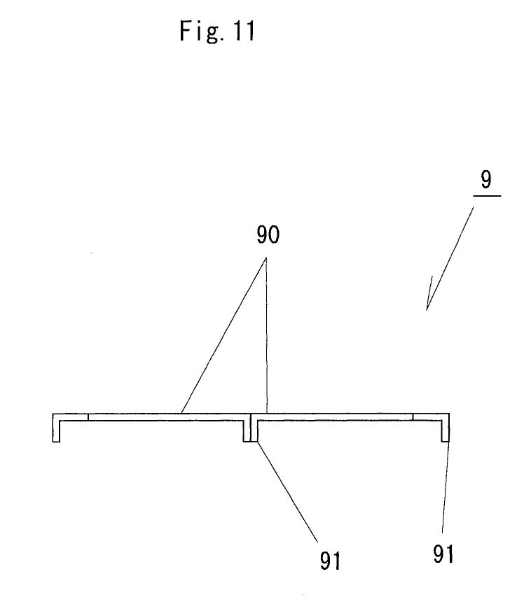

Also as described above, in the unit cell 2 of this embodiment, the support member 9 for supporting the parametric portion of the generating section 3 in the thickness direction is provided between the generating structure 10 and the separator 4. The support member 9 is made as shown in FIGS. 10 and 11 by joining together two pieces of formed stainless steel sheets in the length direction to have a rectangular support plate 90, and legs 91 provided in the center and at both ends of the rectangular support plate 90. The support member 9 as shown in FIG. 7 is approximately the same in size as the communication groove 45. The support member 9 is fixed in the state of the legs 9 being brought into contact, in advance, with the bottom surface of each communication groove 45 of the separator 4. The support plate 90 of the support member 9 is attached to the bottom surface of the vent step groove 53a as shown in FIGS. 3 and 4 in the state of the separators 4 and the generating structure 10 being piled up. The inner end (symbol x in FIG. 3) of the support plate 90 supports the end of the generating section 3 in the thickness direction.

On the basis of the constitution of the separators 4 and the generating structure 10 described above, the constitution of the stack 8 of this embodiment is detailed as below. The stack 8 of the fuel battery 1 of this embodiment is made up by piling up the separators 4 and the generating structures 10 alternately. As shown in FIGS. 3 and 4, the gas diffusion electrodes 30a, 30b on both surfaces of the generating section 3 are brought into contact with the gas supply section 40 of the separator 4 by joining the attachment seat 55 of the spacer 5 to the contact seat surface 48 of the separator 4. At the same time, the raised portion 44 of the separator 4 fits into the fit step groove 53b of the spacer 5 to close it. At the same time, the communication groove 45 within the raised portion 44 joins to the vent step groove 53a of the spacer 5 to form the gas communication passages 11a-11d causing the manifolds 6a-6d to communicate with the gas supply section 40. Therefore, the gas communication passage 11 of the unit cell 2 of this embodiment is formed by joining the grooves formed in the separator 4 as well as in the spacer 5, so that the depth of the gas flow passage relative to the thickness of the unit cell 2 is made deeper than that according to the conventional constitution. This embodiment also makes it possible to increase the width of the gas communication passages 11a -11d up to about the same as the length of each side edge of the square-formed gas supply section 40. Therefore, in the fuel battery 1 according to this embodiment, width of the gas communication passages 11a-11d relative to the size of the unit cell 2 is made far wider than according to the background art. Therefore, even if the width of the gas communication passage of the unit cell 2 is held unchanged, the unit cell 2 of this embodiment may be made thinner than that of the background art, so that the stack 8 may be made with high density without sacrificing output.

In the unit cell 2 of this embodiment as described above, because the perimeter portion (portion x in FIG. 3) of the generating section 3 is supported in the thickness direction by means of the support member 9 provided in the width direction within the gas communication passages 11a-11d, it is possible to support the generating section 3 in stabilized manner without sustaining deformation even if the width of the gas communication passages 11a-11d is made approximately the same as the length of each side edge of the gas supply section 40. Therefore, the generating section 3 of this embodiment may be used even if its thickness is reduced down to the extent that invites reduction in mechanical strength. Therefore, the unit cell 2 may be made thinner.

Further, because the separator 4 of this embodiment is made of a single metallic sheet, it is suited for reducing thickness. The raised portion 44 and the gas supply section 40 of the separator 4 may be formed by a pressing process, and therefore they may be made without cut-processing the metallic sheet.

As described above, the gas communication passages of the fuel battery according to this embodiment may be made large both in thickness and width relative to the constitution of the unit cell. Therefore, even if the thickness of the unit cell 2 is reduced, it is possible to circulate sufficient gas and make the fuel battery stack of a high density without undergoing reduction in output.

This invention is not limited to the constitutions and methods of the above embodiments but may be appropriately changed within the scope of the invention. For example, the shapes of the communication groove 45 of the separator 4, the vent step groove 53a and the fit step groove 53b of the spacer 5 are not limited to those described in the embodiments but may be changed appropriately. For example, in the above embodiment, while the communication groove 45 and the vent step groove 53a are made approximately conforming to each other, they need not completely conform as long as gas communication passages having depth may be formed by joining them.

Further, while the above embodiment uses the proton conducting gel as the constituent material of the electrolyte layer, any other material may be used as the constituent material as long as the same generating structure 10 as in the above embodiment may be formed. In that case, the generating section 3 and the spacer 5 need not be united into an inseparable form.

Some of the conventional proton-exchange membrane fuel batteries are known to have a constitution in which cooling water is circulated through the stack. As for the fuel battery of this invention too, it is possible to combine appropriately with existing cooling mechanism such as forming manifolds for circulating cooling water through the stack, or interposing a unit cell having a cooling water passage between the unit cells at certain number of unit cell intervals. Although no mention is made in the description of the above embodiment, it is preferable to appropriately fill the gap between the separator and the generating structure of this invention by appropriately using gaskets and grease for preventing gas leakage. Such a gas leak preventing structure may be appropriately added to embodiments of the present invention.

1. A fuel battery made by stacking a plurality of generating structures, each generating structure comprising a square shaped generating section made by joining gas diffusion electrodes to both surfaces of an electrolyte layer, comprising:
an insulating spacer surrounding parametric edge of the generating section, wherein the spacer includes a center opening for containing the generating section in alignment, the center opening having a perimeter and four side edges;
a plurality of separators, each separator formed in its center with a gas supply section having a contact for contacting the generating section, wherein an upside and an underside of the center opening is formed with an attachment seat for attaching to the separator;
a gas flow groove, seated over the generating structure such that the gas supply section faces the generating section;
a wide vent opening on each of the four side edges of the center opening, whereby an area between each vent opening and each side edge of the center opening contains vent step grooves for passing gas and fit step grooves to be closed with the separator on the upside and underside of the center opening and placed by turns along the parametric edge;
wherein the separator is composed of metallic sheet and is formed with square gas supply sections, the parametric sections are formed with four wide vent holes respectively conforming to the vent openings of the spacer in the direction of the plurality of generating structures; and
a raised portion on a side of the separator for fitting into the fit step groove is formed between each side edge of the gas supply section and each vent hole, wherein each raised portion forms a communication groove communicating with the vent hole and the gas supply section along the planar direction and joins with the vent step groove of the spacer.

2. The fuel battery of claim 1, wherein the gas supply sections on both surfaces of the separator comprise a plurality of projections projecting on both surface sides and having contact portions near the peaks for contacting the generating section, and mesh-like gas flow grooves formed among the peaks of the projections.

3. The fuel battery of claim 1, further comprising a support member placed in the width direction inside the mutually joined vent step groove and communication groove to bring the inside end on the vent step groove side into contact with the end portion of the generating section in the thickness direction.
